(19) United States
(12) Patent Application Publication
(10) Pub. No.: US 2009/0309344 A1
(43) Pub. Date: Dec. 17, 2009

(54) RESTRAINT SYSTEMS FOR USE IN VEHICLES AND METHODS OF RESTRAINT

(76) Inventors: Linda van Roosmalen, Verona, PA (US); Ilona de Jongh, Den Haag (NL); Patrick Girardin, North Miami Beach, FL (US)

Correspondence Address: DAVID I. ROCHE;BAKER & MCKENZIE LLP, 130 EAST RANDOLPH DRIVE, CHICAGO, IL, 60601, US

(21) Appl. No.: 12/426,208

(22) Filed: Apr. 17, 2009

Related U.S. Application Data
(60) Provisional application No. 61/045,715, filed on Apr. 17, 2008.

(51) Int. Cl. B60R 22/00

(52) U.S. Cl. 280/801.1

(57) ABSTRACT

A safety restraint system to restrain a wheelchair-seated person in a vehicle includes a belt including a pelvic restraining portion connectable between a first side and an second side. The system also includes a structural system to maintain the pelvic restraining portion at a sufficient height when the pelvic restraining portion is connected between the first side and the second side of the vehicle to allow the wheelchair-seated person to move the wheelchair forward to be restrained by the pelvic restraining portion. The structural system can, for example, maintain the pelvic restraining portion above the each of knees of the wheelchair-seated person.

### CROSS-REFERENCE TO RELATED APPLICATION

This application claims benefit of U.S. Provisional Patent Application No. 61/045,715, filed Apr. 17, 2008, the disclosure of which is incorporated herein by reference.

### GOVERNMENTAL INTEREST

These inventions were made with government support under grant no. H133E060064 awarded by the National Institute on Disability and Rehabilitation Research—Department of Education. The government has certain rights in these inventions.

### BACKGROUND OF THE INVENTIONS

The present inventions relate to safety restraint systems for use in vehicles and to methods of restraint, and, particularly, to wheelchair accessible restraint systems for use in vehicles and to methods of restraining vehicle occupants seated in wheelchairs.

The following information is provided to assist the reader to understand the embodiments disclosed below and the environment in which they will typically be used. The terms used herein are not intended to be limited to any particular narrow interpretation unless clearly stated otherwise in this document. References set forth herein may facilitate understanding of the present inventions or the background of the present inventions. The disclosure of all references cited herein are incorporated by reference.

Current Original Equipment Manufacturer (OEM) occupant restraint systems (including, for example, pelvic and/or shoulder restraints or straps) are difficult to use by individuals with limited dexterity and/or arm function. For example, current restraint system buckles and latch plates are often difficult to reach and difficult to use. Such components can, for example, be slippery and difficult to operate or don. Moreover, a precision grip may be needed to place a latch plate into a buckle. In addition, when wheelchairs are used as motor vehicle seats, wheelchair armrests often interfere with the operation of seat belt systems when the individual seated in the wheelchair drives into the driver or passenger station of a motor vehicle. Also, when a wheelchair user wears postural supports they are often unable to rotate and move their upper body, making it difficult to reach for and position the shoulder belt and pelvic belt.

It is desirable to develop improved occupant restraint devices, systems and methods that reduce or eliminate the above and/or other problems associated with current restraint devices, systems and methods.

### SUMMARY OF THE INVENTIONS

In one aspect, the present inventions provide a safety restraint system to restrain a wheelchair-seated person or a wheelchair occupant in a vehicle including a harness or belt system including a lap or pelvic restraining portion connectable between a first side and a second side. It is contemplated that the safety restraint system would be used in conjunction with a separate restraint for the wheelchair, for example, through the use of four-point tie-down system or a docking system like the QLK-100 docking system sold by Q'Straint of Fort Lauderdale, Fla. USA. As used herein, the term “belt” is used to refer to any type of extending flexible harness used in restraint systems. Such belts often, for example, include flexible webbing formed from polymeric materials as known in the seat belt and/or transportation arts. The system also includes a structural system to maintain the pelvic restraining portion at a sufficient height when the pelvic restraining portion is connected between the first side and the second side to allow the wheelchair-seated person to move the wheelchair forward to be restrained by the pelvic restraining portion. The structural system can, for example, maintain the pelvic restraining portion above the knees of the wheelchair-seated person.

The first side can, for example, be on an inboard side of the vehicle and the second side can, for example, be on an outboard side of the vehicle. Other orientations of the safety restraint systems of the present inventions within a vehicle are possible. In general, the wheelchair-seated person drives the wheelchair forward (with respect to the orientation of the wheelchair-seated person) into the safety restraint systems described herein, sometime referred to herein as a “rear entrance”. As the wheelchair-seated person locks the vehicle into the docking system (if used), they are also securing themselves into the safety restraint system. As clear to one skilled in the art, the safety restraint systems described herein can be present in many types of vehicles for restraint at a drive station or at a passenger station. Passenger stations can be in the front of the vehicle or in the rear of the vehicle. Passenger stations need not be oriented in the same orientation as the vehicle. Indeed, the passenger station may be oriented in a forward facing, rear facing, side facing, or other direction. Moreover, multiple safety restraint systems can be included in a single vehicle.

In several embodiments, the structural system includes a guide member, such as a sleeve or channel, through which the pelvic restraining portion passes, the guide member being stiffer than the belt. In several such embodiments, the structural system includes a first sleeve through which the pelvic restraining portion passes on the first (for example, inboard) side of the pelvic restraining portion and a second sleeve through which the pelvic restraining portion passes on the second (for example, outboard) side of the pelvic restraining portion. The first sleeve and the second sleeve can be of sufficient length and sufficient stiffness to maintain the pelvic restraining portion at the sufficient height. The sufficient height can, for example, be above the knees of the wheelchair-seated person. Preferably, the sufficient height is below at least a forward portion of an armrest of the wheelchair so that the pelvic restraining portion can contact the person in the vicinity of the thigh-abdominal junction of the person. The belt can further include a shoulder restraint portion.

In a number of embodiments, the structural system includes a first support structure on the first side and a second support structure on the second side. The pelvic restraining portion can extend between an end of the first support structure and an end of the second support structure. The first support structure and the second supports structure can, for example, maintain the pelvic restraining portion at a height above the knees of the wheelchair-seated person (for example, as the wheelchair is moved into connection with the safety restraint system). In several embodiments, the first support structure is in pivotable connection with the vehicle and the second support structure is in pivotable connection with the vehicle. A first axis about which the first support structure is pivotable can be positioned at a first position to the rear of the thigh-abdominal junction (with reference to the orientation of the wheelchair-seated person) of the person when the person is restrained within the safety restraint system. Also, a second axis about which the second support structure is pivotable can be positioned at a second position to the rear of the thigh-abdominal junction of the person when the person is restrained within the safety restraint system. The first axis and the second axis can be generally collinear. Each of the first support structure and the second support structure can, for example, independently form an angle in the range of approximately 45 to 75° with respect to vehicle the floor when the person is restrained within the safety restraint system, in order to comply with the preferred current lap/shoulder belt geometries referred to in SAE J2249 guidelines. However, the support structures may have a free range of movement well in excess of that range. In some of the embodiments, the first support structure and second support structure are capable of forming an angle of approximately 90° with respect to the vehicle floor to maintain the pelvic restraining portion at a height above the knees of the wheelchair-seated person as he/she enters the safety restraint system, and can rotate to an angle of 30° or more as the person is steering into position.

In several embodiments, a length of the first support structure is adjustable and a length of the second support structure is adjustable. The length of the first support structure can, for example, be adjustable via cutting and/or telescoping, and the length of the support structure sleeve can, for example, be adjustable via cutting and/or telescoping.

In several embodiments, the first support structure includes a first sleeve through which the pelvic restraining portion passes on the first side and a the second support structure includes a second sleeve through which the pelvic restraining portion passes on the second side. The first sleeve and the second sleeve can, for example, be formed from a polymeric material.

In another aspect, the present inventions provide a method of restraining a wheelchair-seated person in a vehicle, including: providing a belt comprising a pelvic restraining portion connected between a first side and a second side, and providing a structural system to maintain the pelvic restraining portion at a sufficient height between the first side and the second side of the pelvic restraining portion to allow the wheelchair-seated person to move the wheelchair forward to be restrained by the pelvic restraining portion.

In a further aspect, the present inventions provide a safety restraint system to restrain a wheelchair-seated person in a vehicle, including a first support structure on a first side, the first support structure being pivotable to a first range of angles, a second support structure on a second side, the second support structure being pivotable to a second range of angles, and a belt system comprising a pelvic restraining portion connectable between the first side support structure and the second support structure. The pelvic restraining portion can, for example, be removably connectable to one or more of the first support structure and the second support structure.

In several embodiments, a first axis about which the support structure is pivotable is positioned at a first position to the rear of the thigh-abdominal junction of the person when the person is restrained within the safety restraint system and a second axis about which the second supports structure is pivotable is positioned at a second position to the rear of the thigh-abdominal junction of the person when the person is restrained within the safety restraint system. The first axis and the second axis can be generally collinear. The first position can be adjustable, and the second position can be adjustable.

The first support structure can be biased to return to a first predetermined position when the wheelchair-seated person is not restrained by the safety restraint system. Likewise, the second support structure can be biased to return to a second predetermined position when the wheelchair-seated person is not restrained by the safety restraint system. The first support structure and the second supports structure can, for example, maintain the pelvic restraining portion at a height above the knees of the wheelchair-seated person when the first support structure is in the first predetermined position and the second support structure is in the second predetermined position.

The devices, systems and methods described herein allow a wheelchair-seated individual to remain seated in their wheelchair when driving or riding in a motor vehicle. The individual can drive the wheelchair into the driver station or a passenger station of a vehicle to achieve a “rear entrance” into a restraint system of the present inventions.

The present inventions, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a perspective view of one embodiment of a restraint system of the present inventions including a support structure in the form of a sleeve to maintain a lap or pelvic belt portion of a seat belt above a wheelchair-seated user's knees.

FIG. 2 illustrates a perspective view of another embodiment of a restraint system of the present inventions including an inboard support structure and an outboard support structure to maintain a lap or pelvic belt portion of a seat belt above a wheelchair-seated user's knees.

FIG. 3 illustrates an enlarged perspective view of the inboard and outboard support structures of the system of FIG. 2.

FIG. 4A illustrates an enlarged side view of the inboard support structure.

FIG. 4B illustrates an enlarged, perspective disassembled or exploded view of the rotatable or pivotable connection of the inboard support structure.

FIG. 4C illustrates a method of adjusting the length of an inboard or outboard sleeve of the present inventions, wherein the inboard sleeve is depicted as a representative example.

FIG. 5A illustrates a side view a wheelchair-seated user in motion toward the system of FIG. 2.

FIG. 5B illustrates a side view of a wheelchair-seated user restrained within the system of FIG. 2.

FIG. 5C illustrates a perspective view of a wheelchair positioned within the system of FIG. 2 without a user therein.

FIG. 6 illustrates a perspective view of another embodiment of a restraint system of the present inventions including an inboard support structure or member and an outboard support structure or member to support a lap or pelvic belt portion of a seat belt.

FIG. 6A illustrates an embodiment of a dedicated belt system suitable for use in the restraint systems of the present inventions.

FIG. 7 illustrates a perspective view of the restraint system of FIG. 6 wherein a connector of the pelvic belt portion is removed from operative connection with the inboard support structure and maintained or “stored” in connection with a cooperating connector of the outboard support structure so that the pelvic belt portion does not extend between the inboard and outboard support structures.

FIG. 8 illustrates a perspective view of the restraint system of FIG. 6 wherein a connector of the pelvic belt portion is removed from connection with a cooperating connector of the outboard support structure and maintained or “stored” in operative connection with the inboard support structure so that the pelvic belt portion does not extend between the inboard and outboard support structures.

FIG. 9 illustrates a perspective view of the restraint system of FIG. 6 wherein the belt system includes a separate shoulder restrain belt and pelvic restraint belt.

FIG. 10A illustrates a side view of an embodiment of a floor-mounting support structure, which is an alternative to the support structure shown in FIG. 4A.

FIG. 10B illustrates a rear view of the support structure of FIG. 10A.

FIG. 10C illustrates an enlarged rear view of a biasing connector bracket assembly of the support structure of FIG. 10A.

FIG. 10D illustrates an enlarged perspective view of a biasing connector bracket assembly of the support structure of FIG. 10A.

FIG. 11 illustrates an alternate embodiment of the support structure that is mounted to the floor of a vehicle using an L-Track and fitting.

FIG. 12 illustrates a side sectional view of an alternate embodiment of a male connector which includes a belt tensioning mechanism.

### DETAILED DESCRIPTION OF THE INVENTIONS

In several embodiments, the devices, systems and methods of the present inventions address the problems of wheelchair-seated individuals who find it difficult or impossible to use standard (Original Equipment Manufacturer—OEM) or even non-standard, specialized vehicle mounted seat belts or to drive into a vehicle mounted seat belt system when preparing to operate or to be a passenger in a motor vehicle.

In several embodiments, the devices, systems and methods of the present inventions enable wheelchair-seated individuals, including those with limited reach, hand and arm function or limited dexterity, to easily and independently drive into a pre-buckled or pre-connected, vehicle-mounted seat belt system, without the need to reach for, lift over knees or touch (with hands) the belt(s) and/or buckles, or otherwise connect a pelvic belt and/or a shoulder belt. The systems of the present inventions are readily adapted for use with currently available OEM seatbelts used in vehicles.

Currently available pelvic restraint systems include flexible webbing-style belts that are typically connected to the bottom of the B-pillar on the vehicle outboard side and are run directly to be connected to a buckle receiver on the inboard side of the vehicle. The B-pillar is the roof support and structural member located between a vehicle's front door and rear side window.

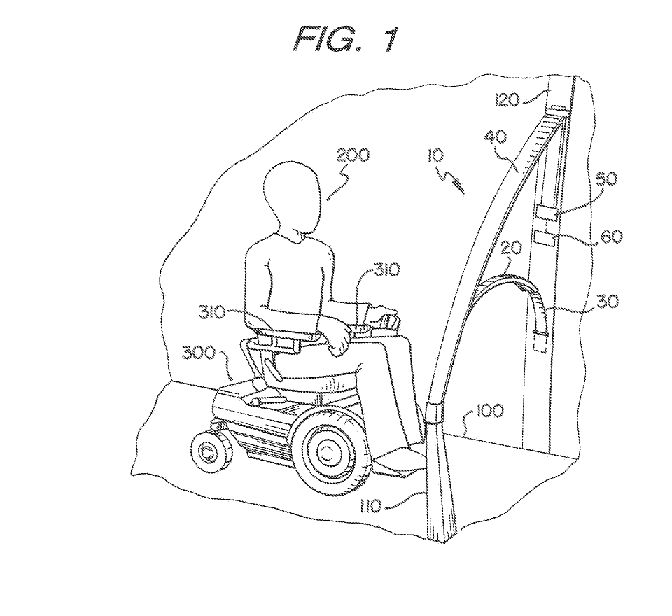

In one embodiment of the present inventions as illustrated in FIG. 1, a system 10 includes a relatively stiff seat belt sleeve 20 that can, for example, include a preformed, semi-stiff polymeric or plastic cover. Cover or sleeve 20 is placed around a part of a lap belt or pelvic restraining portion 30 of the seat belt. Sleeve 20 is preferably sufficiently stiff to prevent pelvic belt portion 30 from hanging down, making it unnecessary for a user 200 to reach for it and lift the pelvic belt up when driving into pre-connected seat belt system 10. However, sleeve 20 is also preferably sufficiently flexible to maintain the user in comfort. Sleeve 20 can be used in combination with a standard seat belt system including pelvic belt 30 and a shoulder belt or shoulder restraining portion 40 as illustrated in FIG. 1. Pelvic belt portion 30 and a shoulder belt portion 40 (which, in the illustrated embodiment, are portions or sections of the same continuous belt) can be connected to a vehicle 100 at a console 110 on the inboard side and at B-pillar 120 on an outboard side. Sleeve 20 can, for example, be rotatably connected to console 110 and extend a sufficient length to prevent pelvic belt portion 30 from hanging down below the knees of wheelchair-seated user 200. In the illustrated embodiment, system 10 remains in a connected state so that user 200 can drive the user's wheelchair 300 into the system. When the user drives into system 10, the seat belt is, for example, pulled out of its retractor 50 at the outboard shoulder belt anchor (as known in the art). Retractor 50 can, for example, be in operative connection with a control system 60 which can, for example, include a motor, one or more sensors and a controller so that tension of the seat belt restraint is automatically regulated to provide the user with a snug and safe fit when the user is positioned within safety restraint system 10. Sleeve 20 is readily customizable or adjustable to any height to, for example, ensure that pelvic belt portion 30 of the seat belt is higher than the user's knee, but lower than optional armrests 310 of wheelchair 300. User 200 then drives in the system, pulling the seat belt with user 200 as it comes in contact with the thigh-abdominal junction of user 200. System 10 and other systems of the present inventions can, for example, be readily adapted for use with wheelchairs conforming to the WC19 standard (WC19 Wheelchairs Used as Seats in Motor Vehicles approved by ANSI/RESNA) and/or other design guidelines and having an “open armrest” design.

The vertical height of the sleeve 20 can adjusted by the sleeve length. The preformed sleeve 20 is attached to upper arms 426a. The shorter the sleeve 20 is, the lower the arc across the user 200 becomes. Alternatively, the sleeve can be formed of a firm and flexible material that can be shaped, for example, via hand or by the use of heat and or tools.

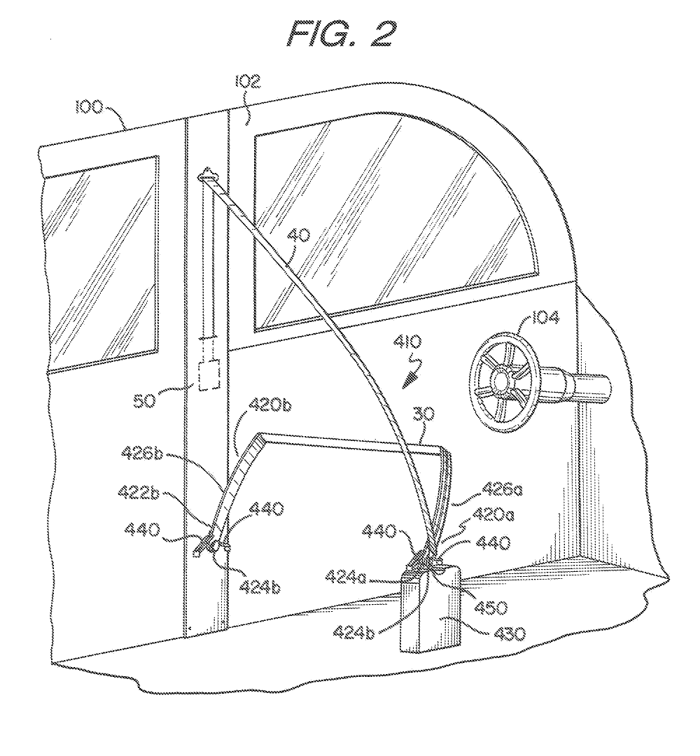

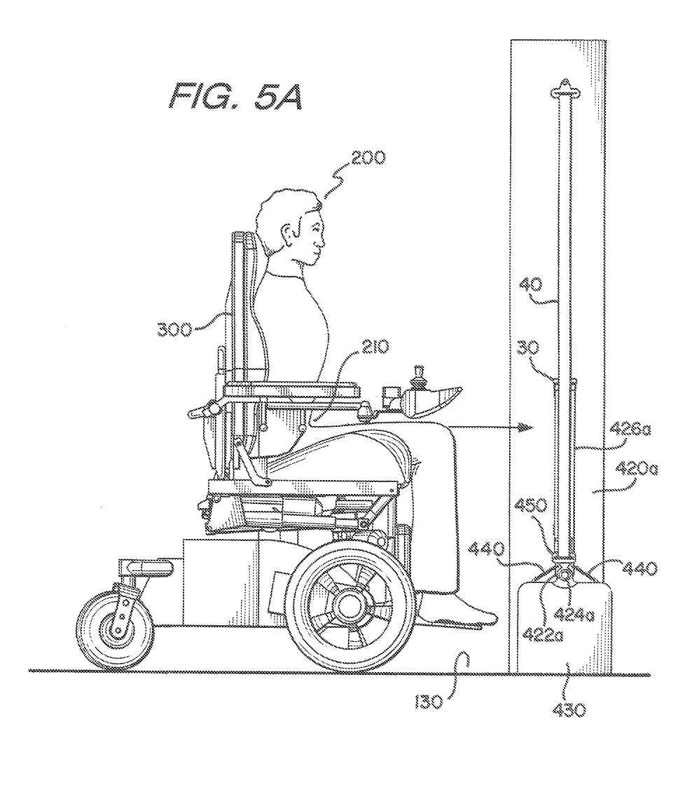

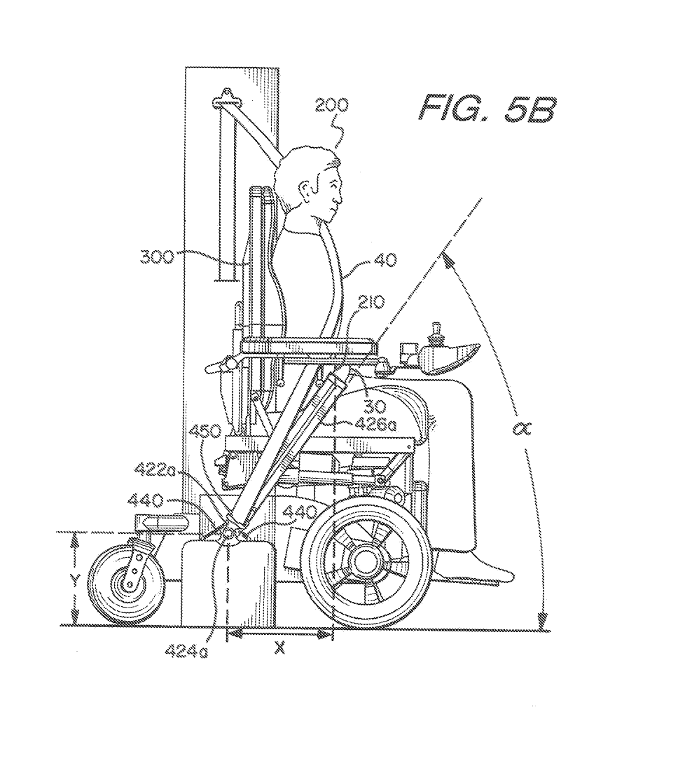

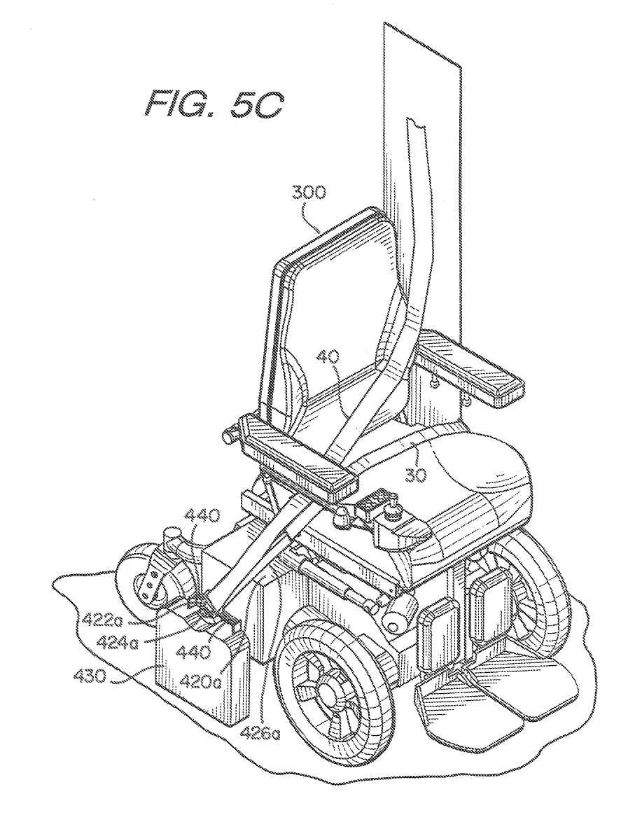

FIGS. 2 through 5C illustrates another embodiment of a system 410 of the present inventions positioned at a drivers station of a vehicle 100 adjacent driver's side door 102 and steering wheel 104. System 410 includes a support system including an inboard support structure 420a and an outboard support structure 420b which can, for example, rotate or pivot about an axis A which is located to the rear of the thigh-abdominal junction 210 (see, for example, FIGS. 5A and 5B) of wheelchair-seated occupant or user 200 when user 200 is restrained within system 410. Alternatively, inboard support structure 420a and outboard support structure 420b can be fixed at a desired angle or range of angles for a particular user. The terms “inboard” and “outboard” are used to refer to a first side and a second side in connection with several embodiments of the present inventions as, for example, illustrated in FIGS. 2 through 5C. Once again, however, passenger restraint stations need not be oriented in the same orientation as the vehicle; thus, use of the term “inboard” and “outboard” is used herein for convenience purposes only and is not intended to limit the passenger station to any particular orientation in a vehicle.

In the illustrated embodiment, each of support structures 420a and 420b includes an anchor member 422a and 422b, respectively, which is rotatably or pivotably mounted to vehicle 100 via bolt members 424a and 424b, respectively. Support structures 420a and 420b also include sleeves 426a and 426b, respectively, through which pelvic belt portion 30 is passed. As described above, pelvic belt portion 30 and shoulder belt portion 40 can be portions or sections of the same continuous seat belt. Pelvic belt portion 30 and shoulder belt portion 40 can also be formed separately. In the illustrated embodiment, the seat belt begins at anchor member 422b, passes through outboard sleeve 426b, exits the top of outboard sleeve 426b, extends generally parallel to vehicle floor 130, enters the top of inboard sleeve 426a, exits the bottom of inboard sleeve 426a, forming pelvic or pelvic belt portion 30. After exiting the bottom of inboard sleeve 426a, the seat belt passes through a connector 450 (for example, a male buckle latch, as known in the seat belt or transportation arts, which is rotatably or pivotably connected to bolt member 424a), and extends upward to terminate at a connector system 50 (see FIG. 2; which can include a retraction or tensioning system) to form shoulder belt portion 40.

The anchor points (defined by the shafts of bolts 424a and 424b) defining axis A can, for example, be installed to ensure that the pelvic belt portion 30 of the seat belt makes an angle within a desired range of angles α (for example, in the range of approximately 45° to 75°) with respect to vehicle floor 130 upon driving wheelchair 300 into system 410 to its secured position into an automated or manual wheelchair securement system. The anchor points can be chosen for the comfort of the user so that an angle in the desired range (for example, 45° to 75°) is formed. A distance can be calculated from the thigh-abdominal junction, using the following formula:

Tan α=(abdominal junction height−y)/x, where 45°≦α≦75° for effective restraint

wherein, x (see FIG. 5B) is the distance between the installation spot (securement location, i.e., axis A) and the (forward positioned) thigh-abdominal junction of the user and y (see FIG. 5B) is the height of axis A (in the shown embodiment, bolts 424a and 424b) above the vehicle floor.

As described above, in system 410, pelvic or pelvic belt portion 30 of the seat belt rises up adjacent the vehicle outboard side B-pillar 120 through relatively stiff outboard sleeve 426b that is rotatably or pivotably connected at the lower end thereof to vehicle 100, for example, at B-pillar 120 (alternatively, the sleeve 426b can be pivotably connected at the lower end thereof to the floor of the vehicle 100). At the top of outboard sleeve 426b, the pelvic belt 30 runs out generally horizontally (that is, generally parallel to vehicle floor 130) toward inboard sleeve 426a to preferably maintain pelvic belt 30 above the knees of wheelchair-seated user 200. Inboard sleeve 426a is rotatably or pivotably mounted to the inboard side of vehicle floor 130 via a structure or console 430. Each of sleeves 422a and 422b of support structures 420a and 420b is thus pivotably connected to vehicle 100 so that user 200 can drive into lap or pelvic belt/restraint portion 30 (with knees underneath generally horizontal pelvic belt portion 30) of the seat belt and tension the seat belt. The pivoting of support structures 420a and 420b, upon forward movement of wheelchair occupant 200 and contact with pelvic belt 30, thus results in automatic positioning and tightening of pelvic belt 30 around the wheelchair occupant's pelvis. Such positioning and tightening occurs, at least in part, as a result of the pivoting (forward and downward) motion of pelvic belt 30 which extends between the upper ends of pivotable support structures 420a and 420b.

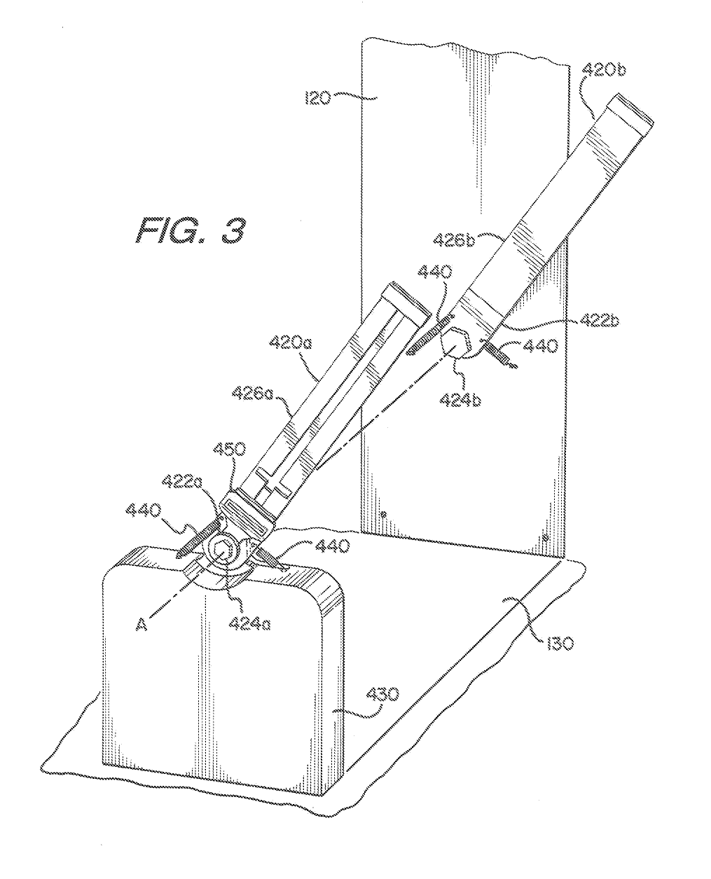

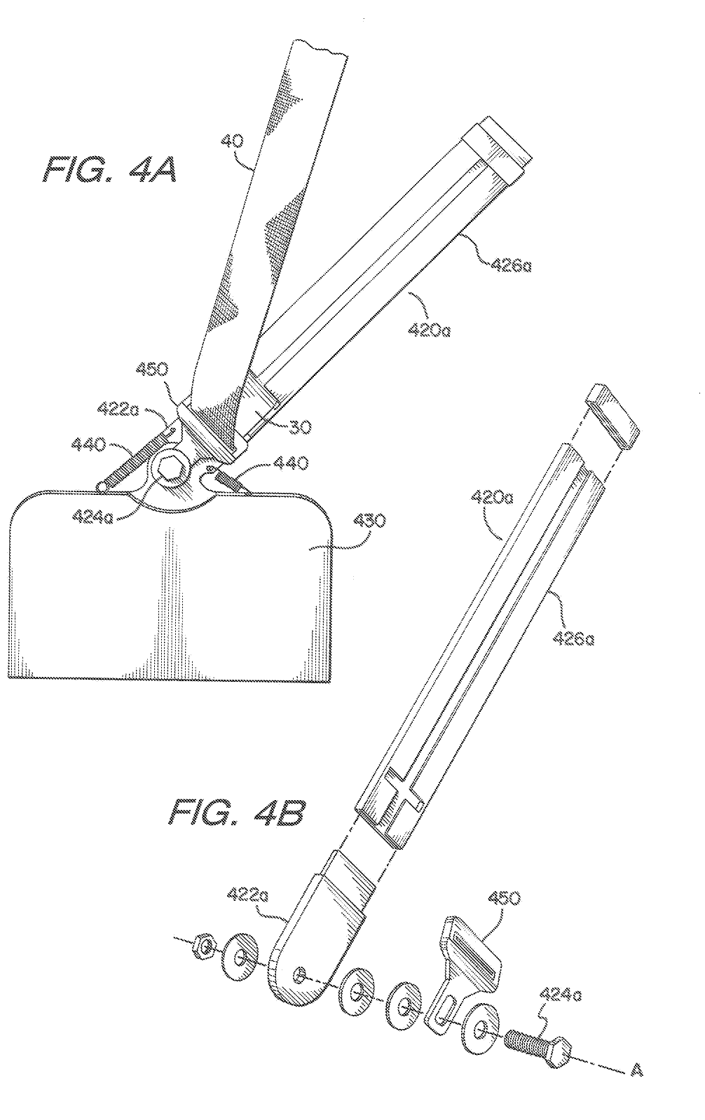

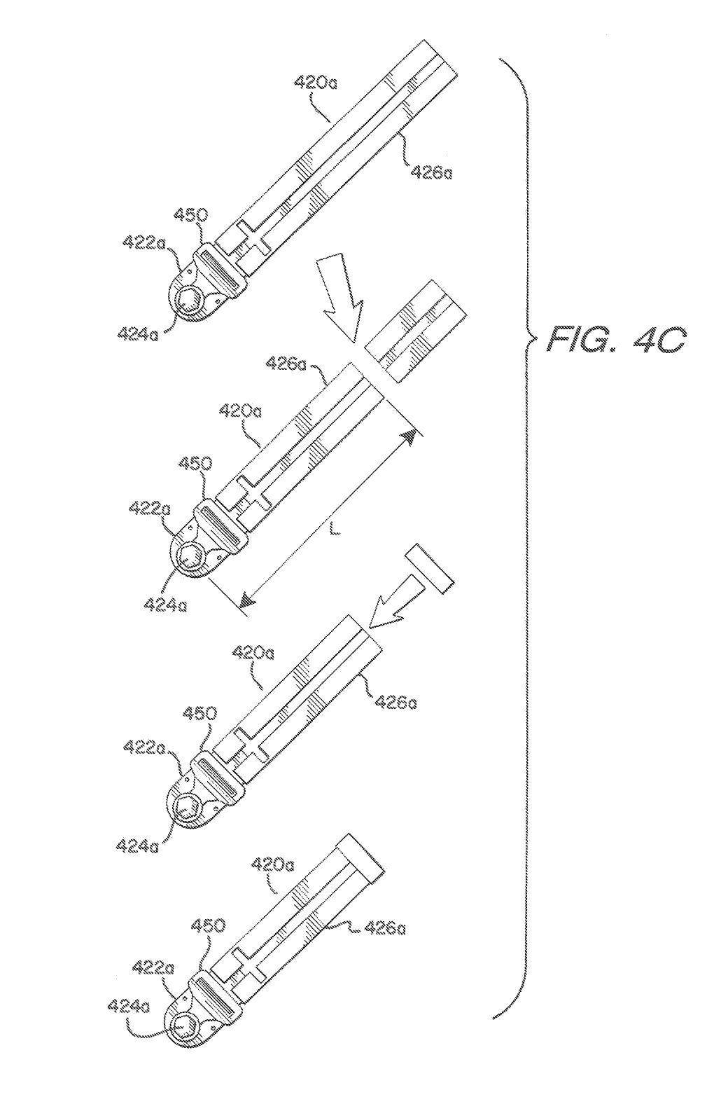

As illustrated in FIGS. 3 and 4, one or more biasing element such as springs 440 can be provided in operative connection with, for example, the lower portions of one or both of support structures 420a and 420b to bias/return pelvic belt portion 30 to a desired position after user 200 backs wheelchair 300 out of system 410. In the examples illustrated, the support structures are biased to return to a 90° position in order to “reset” the system and allow the user to re-enter.

As illustrated in FIG. 4C, inboard sleeve 426a and outboard sleeve 426b (which can be generally identical) can be adjusted to a desired length L, for example, by cutting. Alternatively the sleeves can be formed to telescope to various positions to adjust height.

As described above in connection with system 10, tension of the seat belt restraint can readily be automatically regulated to provide the user with a snug and safe fit when the user is positioned within safety restraint system 410.

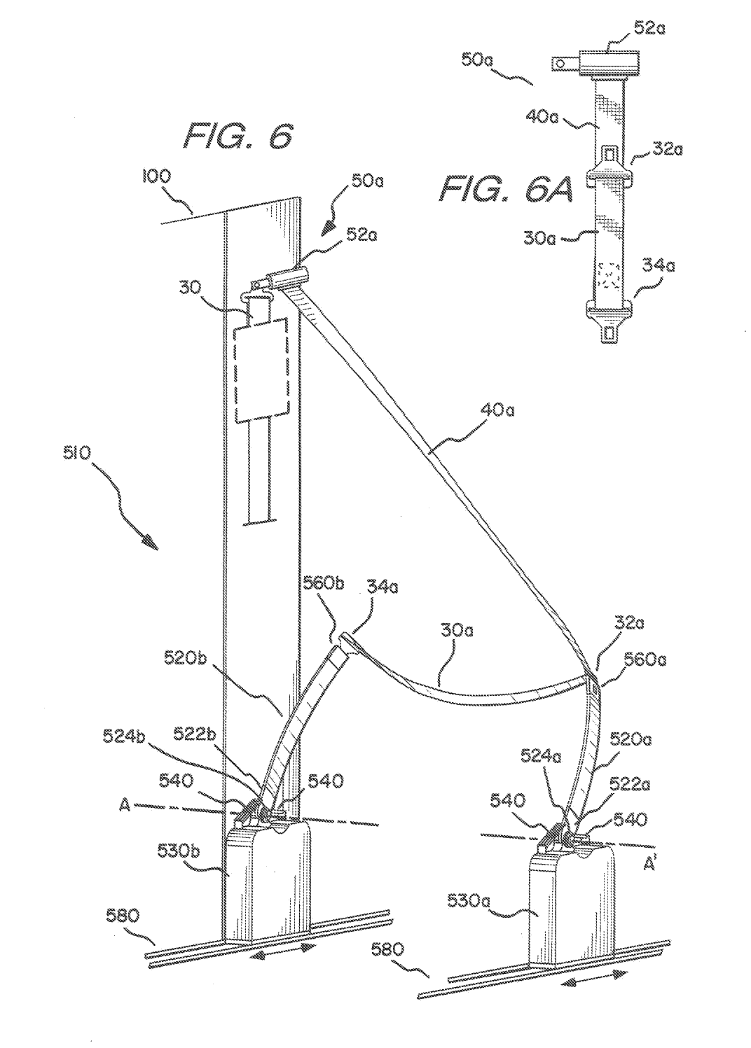

FIG. 6 illustrates another embodiment of a system 510 of the present inventions. System 510 includes an inboard support structure 520a and an outboard support structure 520b which can, for example, rotate or pivot about axes A and A′, respectively, which are, for example, located to the rear of the thigh-abdominal junction 210 (see, for example, FIGS. 5A and 5B) of wheelchair occupant 200 (not shown in FIG. 6) when the wheelchair occupant is restrained within system 510. Inboard support structure 520a and/or outboard support structure 520b can be movably pivotable during use or can be fixed at a desired angle for a particular user.

Similar to support structures 420a and 420b, each of support structures 520a and 520b includes a connector or anchor member 522a and 522b, respectively, which is rotatably or pivotably mounted to vehicle 100 via, for example, shaft or bolt members 524a and 524b, L-track fittings, and L-tracks. (the L-track fittings and L-tracks are shown in schematic form in FIGS. 6-9; see FIG. 11 for an actual view of an L-track fitting and L-track). Alternatively, support structures 520a and 520b can be bolted directly to the floor of the vehicle 100 or other fittings and track such common within the transportation arts. Unlike the case of support structures 420a and 420b, however, a pelvic belt portion 30a is not passed through support structures 520a and 520b, but simply spans between the upper ends thereof.

In the illustrated embodiment, a dedicated belt system 50a (also illustrated in FIG. 6A) is provided, which can, for example, be attached to the B-pillar of the vehicle at a same upper attachment point to which an upper connector or guide of the OEM belt system is attached. In FIG. 6, a portion of the OEM belt system is showed schematically to be stowed in the area of the vehicle B-pillar as represented by a dashed rectangle. In this manner, the securement system 510 does not interfere with the OEM belt system, which therefore can be used by an able-bodied person to drive the vehicle as well, by means of replacing the regular driver/front passenger pilot chairs. Pelvic belt portion 30a and shoulder belt portion 40a of dedicated belt system 50a are portions or sections of the same continuous belt or webbing, but pelvic belt portion 30a and shoulder belt portion 40a can be formed separately as described above.

In the embodiment illustrated in FIG. 6, shoulder belt portion 40a of the belt or harness system begins at a source 52a (for example, a retractor) connected to the vehicle and passes through a connector or guide 32a (for example, a male buckle latch as known in the seat belt or transportation arts), which can be movable or slidable on the continuous belt. In general, the position of connector 32a defines the separation point between shoulder belt portion 40a and pelvic belt portion 30a. As described further below, the position of guide 32a on the continuous belt can be fixable or lockable in several embodiments. Pelvic belt portion 30a of the continuous belt terminates in a connector 34a (for example, a male buckle latch as known in the seat belt or transportation arts).

Connector 32a is connectable to a cooperating connector 560a (for example, a female buckle connector as known in the seat belt or transportation arts) at the upper end of support structure 520a. Upon connection of connector 32a to cooperating connector 560a, pelvic belt portion 30a is extended generally parallel to vehicle floor 130 or horizontally, and connector 34a is connected to a cooperating connector 560b (for example, a female buckle connector as known in the seat belt or transportation arts) at the upper end of support structure 520b.

In the illustrated embodiment, inboard support structure 520a is rotatably or pivotably mounted to the inboard side of vehicle floor 130 via a base, structure or console 530a. Similarly, outboard support structure 520b is rotatably or pivotably mounted to the outboard side of vehicle floor 130 via a base, structure or console 530b. Each of support structure 520a and 520b is thus pivotably connected to vehicle 100 so that wheelchair occupant 200 can, for example, drive into pelvic or lap belt/restraint portion 30a (with knees underneath generally horizontal pelvic belt portion 30a) of the seat belt and tension the seat belt. The distance between bases or console structure 530a and 530b can be relatively wide, and one or both of support structures 520a and 520b can, for example, can have an inwardly bending or arced shape (as illustrated in FIG. 6) so that the upper ends of pivoting support structures 520a and 520b are positioned close to the wheelchair occupant's hip point during use.

Similar to system 410, one or more biasing elements 540 (for example, one or more spring loaded elements as known in the mechanical arts) can be provided in operative connection with, for example, the lower portions of one or both of support structures 520a and 520b to return support structures 520a and 520b to a desired position after user 200 backs wheelchair 300 out of system 510.

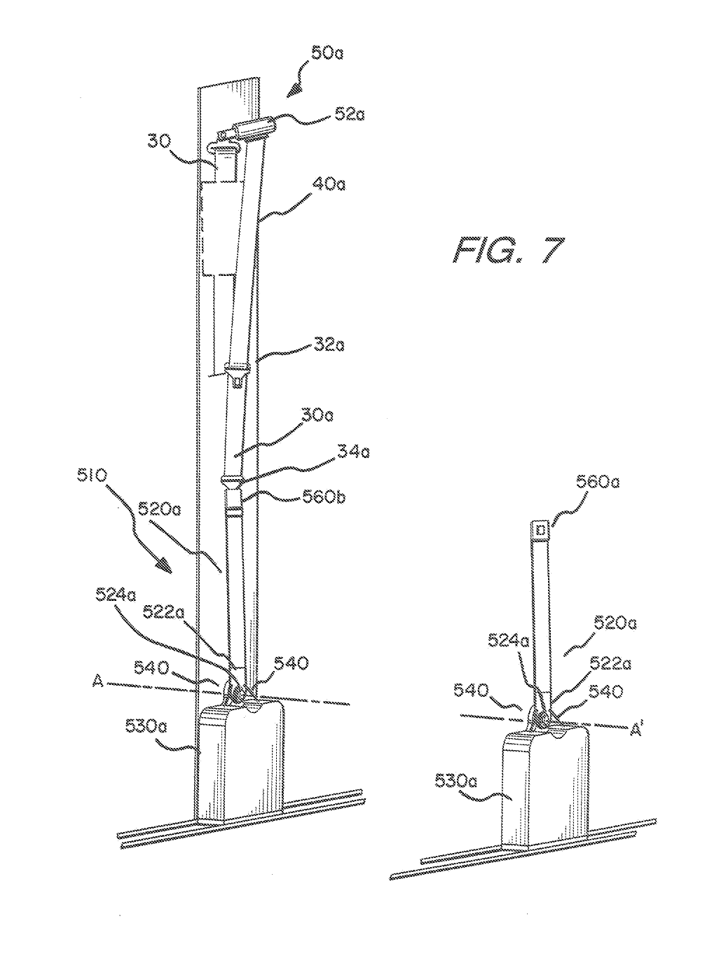

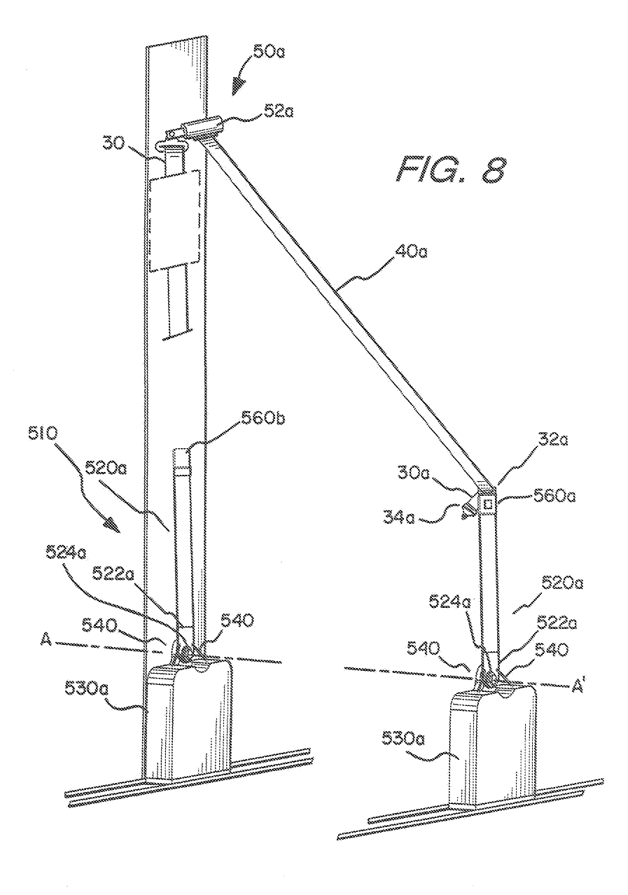

As illustrated in FIGS. 7 and 8, in certain circumstances connector 34a or connector 32a can be disconnected from cooperating connectors 560b or 560a, respectively, during entry of wheelchair user 200 into a suitable position to use system 510 and/or prior to exit of wheelchair user 200 from connection to system 510. The ability to thereby disconnect pelvic belt portion 30a from connection between support structures 520a and 520b can, for example, facilitate suitable positioning and restraint for individuals seated in a wheelchair that has closed or partially closed or obstructed armrests. Closed or partially closed armrests can interfere with or prevent pelvic belt portion 30a (when connected to extend between support structures 520a and 520b) from being positioned across the pelvis and below the abdominal area during forward movement of the wheelchair. Disconnection of pelvic belt connector 30a enables routing of connector 34a and pelvic belt 30a underneath a wheelchair armrest after positioning the wheelchair within support system 510 so that connector 34a can be placed in operative connection with cooperating connector 560b.

Pivotable support structures 520a and 520b ensure that the pelvic belt portion 30a of the seat belt makes an angle within a desired range of angles α (as described above) with respect to vehicle floor 130 whether pelvic belt portion 30a is connected across support structures 520a and 520b before entry of wheelchair 300 into position within system 510 or after wheelchair 300 is so positioned. In FIG. 6, support structures 520a and 520b are illustrated as pivoted forward with respect to the direction of entry or to the right (in the orientation of FIG. 6) as would be the case if a use of a wheelchair such as wheelchair 300 were in restraining connection therewith.

As described above, support structures 520a and 520b can, for example, be fixed or locked at a desired angle α (for example, at an angle between 45° to 75°) or a range of angles α, which can facilitate use with a wheelchair having closed or partially closed armrests. As described above, disconnection of connector 34a from connection with cooperating connector 560a, or disconnection of connector 34b from connection with cooperating connector 560b, enables routing of connector 34a or 34b and pelvic belt 30a underneath a wheelchair armrest after positioning the wheelchair within support system 510. However, disconnection of pelvic belt 30a prevents automatic positioning of supports structures 520a and 520b as occurs when a user's abdomen contacts pelvic belt 30a in embodiments in which pelvic belt 30a is connected between support structures 520a and 520b before the wheelchair is brought into position within system 510. Locking support structures 520a and/or 520b at a desired angle or range of angles for a particular user can also ensure that connector 34a and cooperating connector 560b are at proper positions for ready access.

For example, in the configuration shown in FIG. 7, it is contemplated that support structure 520a could be locked at approximately a 45° position. Once the wheelchair-seated occupant is in position, they are able to manually pull connector 32a, through or behind closed armrest and down into connection cooperating connector 560a. As the occupant manually pulls connector 32a, the support structure 522b is able to move forward to the approximately 45° position. Alternatively, both support structure 522a and 522b could be locked at approximately a 45° position.

In the configuration shown in FIG. 8, it is contemplated that support structure 520b could be locked at approximately a 45° position. Once the wheelchair-seated occupant is in position, they are able to manually pull connector 34a, through or behind closed armrest and down into connection cooperating connector 560b. As the occupant manually pulls connector 34a, the support structure 522a is able to move forward to the approximately 45° position. Alternatively, both support structure 522a and 522b could be locked at approximately a 45° position.

The support structure 520a and 520b can be locked at a desired angle by tightening bolt 524a and bolt 524b, respectively, or through use of a separate lock structure.

Bases 530a and 530b can, for example, be movably mounted on track systems 580 (set forth schematically in FIGS. 6, 7 and 8) to provide independent adjustment of the position thereof on vehicle floor 130 (and thus adjustment of the angle α). In most circumstances, the position of bases 530a and 530b is adjusted so that the axis of rotation of each base 530a and 530b (A and A′ respective in FIGS. 6 through 8) is generally collinear. Suitable track systems are, for example, available from Q′Straint of Fort Lauderdale, Fla. USA (e.g. L-track fitting model Q5-3053-4-2 and flanged L-Track piece Q5-6008-F). One such track system is shown in FIG. 11, connected to a lower end of an alternative embodiment of a support structure.

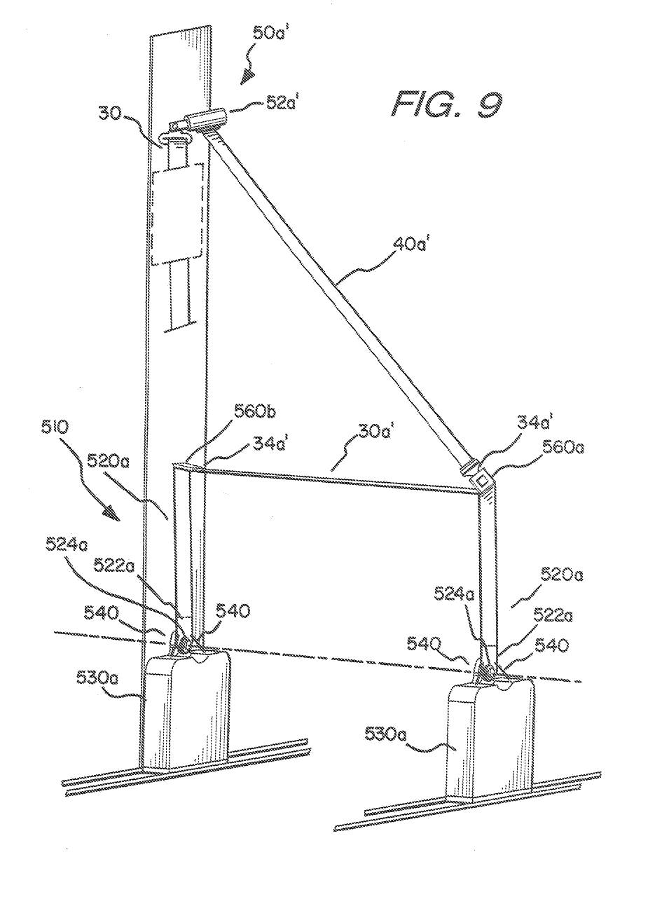

FIG. 9 illustrates system 510 in which a separate shoulder belt portion 40a′ and pelvic belt portion 30a′ are used. Shoulder belt portion 40a′ can, for example, include a connector 32a′ such as a male tongue or latch plate which connects to cooperating connector 560a. Similarly, pelvic portion 30a′ can, for example, include a connector 34a′ such as a male tongue or latch plate which connects to cooperating connector 560b as described above.

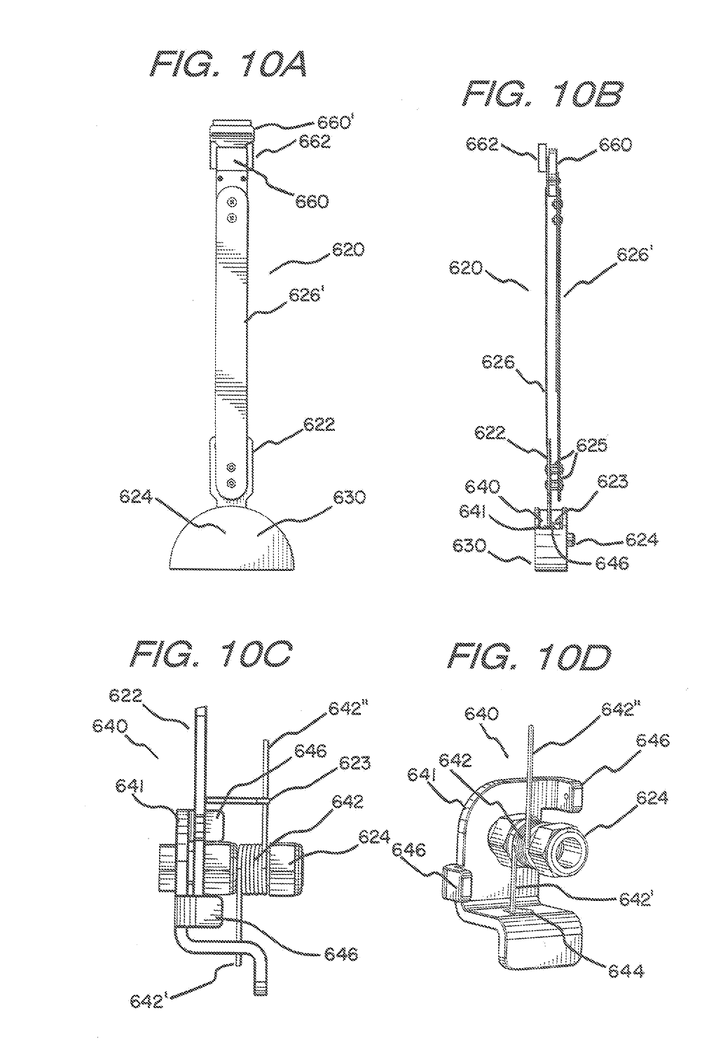

FIGS. 10A through 10D illustrate another embodiment of a support structure 620 and an associated base 630 of the present inventions. In the illustrated embodiment, support structure 620 includes connector member 622 which is pivotably connected to a shaft or bolt member 624 as described above. Support structure 620 further includes a first extending member 626 and a second extending member 626′ (spaced from first extending member 626 via spacers 625—see FIG. 10B), which are connected at first (or lower) end thereof to connector member 622. A second (or upper) end of each of extending member 626 and 626′ is operatively connected to a connector 660 such as a buckle mechanism. When used on an inboard side of a vehicle, connector 660 can, for example, be operatively connected to a belt or webbing connector or guide 660′ such as a male latch plate (see FIG. 10A) as described above (for example, for use in connection with an integral shoulder/pelvic restraint belt system, which is not shown in FIGS. 10A through 10D).

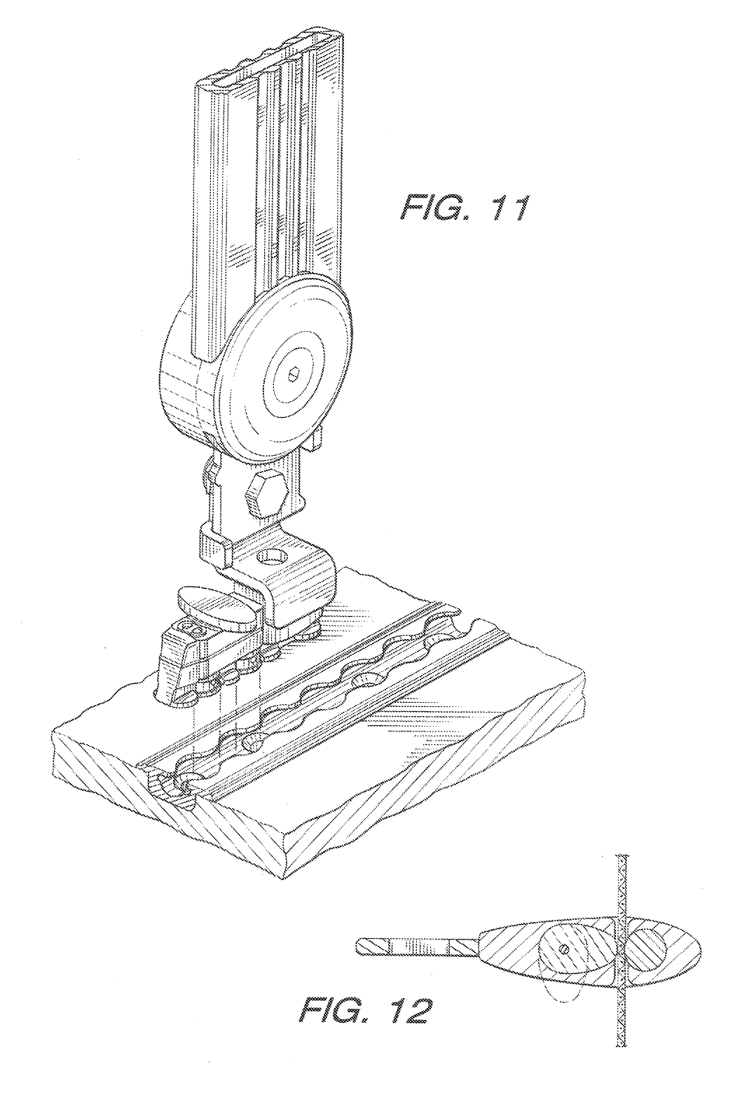

Inboard side, belt/webbing guide or pass-through 660′ can include or have in operative connection therewith a tensioning or locking mechanism 662 (shown schematically in FIGS. 10A and 10b with an alternate embodiment of a connector with tensioning mechanism shown in FIG. 12) to hold onto or tension the belt/webbing, thereby allowing wheelchair occupants to more easily stabilize themselves during, for example, turning and braking. Tensioning or locking mechanism 662 can also provide for slack in the pelvic belt portion of the belt/webbing system (see FIG. 6, although supports 520a and 520b could be oriented at 90° to the floor, and not locked) to, for example, enable the pelvic belt portion to be raised over and possibly behind closed or partially closed armrests while the wheelchair occupant is engaging the system, such that the pelvic belt portion is placed at the thigh-abdominal junction of the person. At this point, the person could manually release the tensioning or locking mechanism 662 to allow the retractor or connector system 50 to remove the excess slack. When the user is ready to exit the system, they may either release the buckle or simply pull out the pelvic belt portion and raise above the wheelchair armrests.

In the embodiment of FIGS. 10A through 10D, a bracket assembly 640 biases support structure 620 into an upright, generally vertical engagement position. Bracket assembly 640 includes a torsion spring 642 through which shaft or bolt member 624 passes before passing through connector 622. Torsion spring 642 includes a first extending member 642′, which engages a passage 644 formed in bracket base 641. A second extending member 642″ engages an abutment member 623 extending from connector 622. In the illustrated embodiment, bracket base 641 includes extending stops, limiters or abutment members 646 to limit the degree of pivoting of connector 622 (and thereby support structure 620). Connector 622 is removed in FIG. 10D to more clearly illustrate bracket assembly 640.

Systems 10, 410, 510 and other systems of the present inventions are readily retrofitted into existing vehicles and can utilize or complement the vehicle OEM shoulder and pelvic restraint belting. In that regard, a separate or dedicated belt system can be provided in the systems of the present inventions. In such a belt system, the shoulder belt can be installed to be tight (that is, without a retractor/no belt slack) to maintain a fixed belt length, which can assist in maintaining a wheelchair occupant/driver with poor upper torso control balanced during turning and braking. Further, the length of the pelvic belt/webbing can, for example, be maintained at a defined length (for example, by locking or tensioning at the location of one support structure end), and/or the shoulder belt/webbing can, for example, be maintained at a defined length (for example, via locking a retractor) so that the wheelchair bound user has better postural support during turns and braking. When an OEM seat is placed in the vehicle, a dedicated belt system of the present inventions can be stowed out of the way and the OEM restraint system can be used for the driver or passenger.

The foregoing description and accompanying drawings set forth the preferred embodiments of the inventions at the present time. Various modifications, additions and alternative designs will, of course, become apparent to those skilled in the art in light of the foregoing teachings without departing from the scope of the inventions. The scope of the inventions is indicated by the following claims rather than by the foregoing description. All changes and variations that fall within the meaning and range of equivalency of the claims are to be embraced within their scope.

What is claimed is:

1. A safety restraint system to restrain a wheelchair-seated person in a vehicle, comprising:
a pelvic restraint extending between a first side and a second side of a wheelchair securement area, and
at least one support holding the pelvic restraint at a sufficient height to allow the wheelchair-seated person to move the wheelchair into the wheelchair securement area to be restrained by the pelvic restraint.

2. The safety restraint system of claim 1 wherein the at least one support holds the pelvic restraint above a knee of the wheelchair-seated person.

3. The safety restraint system of claim 1 wherein the at least one support comprises a sleeve through which the pelvic restraint passes, the sleeve being stiffer than the pelvic restraint.

4. The safety restraint system of claim 1 wherein the at least one support comprises a first support structure on the first side and a second support structure on the second side, the pelvic restraint extending between an end of the first support structure and an end of the second support structure.

5. The safety restraint system of claim 1 wherein the at least one support comprises a sleeve through which the pelvic restraint passes.

6. The safety restraint system of claim 1 wherein the system further comprises a shoulder restraint extending between the first side and the second side of the wheelchair securement area.

7. The safety restraint system of claim 1 wherein the at least one support is in pivotable connection with the vehicle so that the pelvic restraint has an adjustable angle.

8. The safety restraint system of claim 7 wherein an axis about which the at least one support is pivotable is positioned to a rear of a thigh-abdominal junction of the wheelchair-seated person when the wheelchair-seated person is restrained within the safety restraint system.

9. The safety restraint system of claim 8 wherein the at least one of support forms a first angle in the range of approximately 45° to 75° with respect to a vehicle floor when the wheelchair-seated person is restrained within the safety restraint system.

10. The safety restraint system of claim 1 wherein a length of the at least one support is adjustable.

11. The safety restraint system of claim 7 wherein the at least one support is biased to return to a predetermined position when the wheelchair-seated person is not restrained by the safety restraint system.

12. The safety restraint system of claim 6 wherein at least one of the pelvic restraint and the shoulder restraint is maintained at a predefined length to provide postural support.

13. A method of restraining a wheelchair-seated person in a vehicle, comprising:
providing a pelvic restraining portion in a wheelchair securement area of the vehicle, whereby the pelvic restraining portion extends between a first side of the wheelchair securement area and a second side of the wheelchair securement area, and
providing a support to maintain the pelvic restraining portion at a sufficient height to allow the wheelchair-seated person to move the wheelchair into the wheelchair securement area to be restrained by the pelvic restraining portion.

14. A safety restraint system to restrain a wheelchair-seated person in a vehicle, comprising:
a first support structure on a first side of a wheelchair securement area, the first support structure being pivotable to a first range of angles;
a second support structure on a second side of the wheelchair securement area, the second support structure being pivotable to a second range of angles;
a pelvic restraint extendable between the first support structure and the second support structure;
a shoulder restraint extendable between the vehicle and the first support structure;
the first support structure and the second support structure adapted to hold the pelvic restraining portion at a height above a knee of the wheelchair-seated person

15. The safety restraint system of claim 14 wherein the pelvic restraint is removably connectable to at least one of the first support structure and the second support structure.

16. The safety restraint system of claim 14 further comprising at least one locking mechanism for locking at least one of the first support structure and the second support structure at an angle.

17. The safety restraint system of claim 14, wherein the shoulder restraint and the pelvic restraint form a continuous belt, the continuous belt having a first connector for connecting with a first complementary connector on the first support structure and a second connector for connecting with a second complementary connector on the second support structure.

18. The safety restraint system of claim 14 wherein a first axis about which the first support structure is pivotable is positionable at a first range of positions to the rear of a thigh-abdominal junction of the wheelchair-seated person when the wheelchair-seated person is restrained within the safety restraint system and a second axis about which the second supports structure is pivotable is positionable at a second range of positions to the rear of the thigh-abdominal junction of the wheelchair-seated person when the wheelchair-seated person is restrained within the safety restraint system.

19. The safety restraint system of claim 14 wherein the first support structure is biased to return to a first predetermined position when the wheelchair-seated person is not restrained by the safety restraint system and the second support structure is biased to return to a second predetermined position when the wheelchair-seated person is not restrained by the safety restraint system.

20. A method for using the safety restraint system of claim 15 to restrain a wheelchair-seated person, wherein the wheelchair has a closed armrest, the method comprising the steps of:
disconnecting the pelvic restraint from one of the first support structure and the second support structure;
steering the wheelchair into the wheelchair securement area until the thigh-abdominal junction of the wheelchair-seated person is positioned forward of a first pivot axis of the first support structure and a second pivot axis of the second support structure;
feeding the pelvic restraint through the closed armrest of the wheelchair; and,
reconnecting the pelvic restraint to the first support structure or the second support structure.
